(19) United States
(12) Patent Application Publication
(10) Pub. No.: US 2026/0085663 A1
(43) Pub. Date: Mar. 26, 2026

(54) LINEAR SYNCHRONOUS MOTOR-BASED GRAVITATIONAL POTENTIAL ENERGY STORAGE SYSTEM

(71) Applicant: Advanced Rail Energy Storage, LLC, Westlake Village, CA (US)

(72) Inventor: Howard Trott, Kirkland, WA (US)

(21) Appl. No.: 19/334,719

(22) Filed: Sep. 19, 2025

Related U.S. Application Data
(60) Provisional application No. 63/697,391, filed on Sep. 20, 2024.

(51) Int. Cl. F03G 3/00; H02K 1/02; H02K 9/19; H02K 41/03

(52) U.S. Cl. CPC F03G 3/094; H02K 1/02; H02K 9/19; H02K 41/031; F05B 2220/70642; F05B 2220/707

(57) ABSTRACT

A linear synchronous motor-based gravitational potential energy storage system includes mass cars moving along an inclined plane between a lower and upper storage yard. The system comprises tracks guiding the mass cars, with linear synchronous motors positioned along the tracks. Electromagnetic coils interact with permanent magnets that move with the mass cars to produce a linear force. A synchronization mechanism aligns the motors with the electrical grid. Switches control electricity flow to the coils, and an electrical busbar distributes power. A cooling system manages heat. The motors draw electrical energy from the grid to move the mass cars upward, storing potential energy, and convert potential energy into electrical energy as the mass cars descend, feeding the generated energy back into the grid.

### CROSS REFERENCE TO RELATED APPLICATION

This application claims the benefit of U.S. Provisional Application No. 63/697,391, filed Sep. 20, 2024. The prior application is incorporated herein by reference in its entirety.

### FIELD

This disclosure relates generally to systems and methods for energy storage and, in particular, to gravitational potential energy storage systems.

### BACKGROUND

Existing systems for moving objects on an inclined plane often rely on mechanical methods that lack efficiency and energy recovery capabilities. Traditional systems typically use complex control mechanisms, which can introduce inefficiency. These systems do not effectively harness the potential energy generated during the movement process, resulting in wasted energy.

There is a need for a more efficient system that can synchronize with the electrical grid and utilize the energy generated during the movement process. Such a system would streamline operations by eliminating the need for complex control mechanisms and improve overall energy efficiency while converting potential energy into electrical energy.

### SUMMARY

Disclosed herein are various embodiments directed to energy storage solutions for grid-scale energy storage.

The disclosed system utilizes a linear synchronous motor-based system to lower and raise mass on an inclined plane. The linear synchronous motor acts as a generator when lowering the mass down an inclined plane, producing electricity, and acts as a motor when raising the mass up the inclined plane, producing potential energy. The linear motor drive can be synchronous to the alternating current of the electrical grid via electromagnetic coils acting on permanent magnets. The force of the electromagnetic field created between the coils and magnets acts to accelerate and decelerate the moving object (e.g., one or more mass cars).

According to one aspect of the present invention, an energy storage system comprises a track extending between a lower storage yard and an upper storage yard; a first frame system extending along a first side of the track; a second frame system extending along a second side of the track; a plurality of mass cars configured to move along the track between the first frame system and the second frame system, each mass car of the plurality of mass cars having a first side, a second side, and a plurality of permanent magnets configured to move with the mass cars; wherein the first frame system and the second frame system each comprises a plurality of fixed electromagnetic coils; and a plurality of switches positioned on the frame to engage with a respective mass car as it moves along the track, the plurality of switches being operable to control a flow of electricity to the electromagnetic coils to manage their activation and deactivation.

According to another aspect, the energy storage system further comprises an electrical busbar configured to distribute electrical power to and from the electromagnetic coils. According to yet another aspect, the energy storage system further comprises a cooling system configured to dissipate heat generated by the electromagnetic coils. According to another aspect, the energy storage system wherein the cooling system includes a closed-loop water cooling system. According to yet another aspect, the energy storage system wherein the cooling system includes air-based cooling methods.

According to another aspect, the energy storage system has a charging mode and a generator mode, and wherein the energy storage system is configured to draw electrical energy from the electrical grid to move the mass cars from the lower storage yard to the upper storage yard, storing potential energy of the mass cars during the charging mode; and convert the potential energy of the mass cars into electrical energy as the mass cars descend from the upper storage yard to the lower storage yard, feeding the generated electrical energy back into the electrical grid during the generator mode.

According to yet another aspect, the energy storage system further comprises a control system configured to align the operation of the linear synchronous motor-based system with the alternating current of an electrical grid for synchronized operation of the energy storage system.

According to another aspect, the energy storage system wherein the magnets are neodymium iron boron magnets. According to yet another aspect, the energy storage system wherein the switches are mechanical switches that are configured to physically contact the first side or second side of the respective mass car. Alternatively, the switches can be solid state switches.

According to another aspect, a method for storing and generating energy with one or more linear synchronous motors, the method comprises providing a track extending between a lower storage yard and an upper storage yard; positioning a plurality of mass cars configured to move along the track; positioning one or more linear synchronous motors along the track, each linear synchronous motor comprising electromagnetic coils configured to interact with permanent magnets that move with the mass cars to generate a linear force for moving the mass cars along the track; synchronizing the operation of the one or more linear synchronous motors with the alternating current of an electrical grid; and during a charging mode: drawing electrical energy from the electrical grid to energize the electromagnetic coils; moving the mass cars from the lower storage yard to the upper storage yard, thereby storing potential energy in the mass cars; and during a generating mode: allowing the mass cars to descend from the upper storage yard to the lower storage yard; converting the potential energy of the descending mass cars into electrical energy by inducing a current in the electromagnetic coils; and feeding the generated electrical energy back into the electrical grid.

According to yet another aspect, the method further comprises positioning a first frame system extending along a first side of the track and a second frame system extending along a second side of the track, wherein the electromagnetic coils are positioned on the first frame system and on the second frame system.

According to another aspect, the method further comprises positioning a plurality of switches on the first frame system and the second frame system to engage with both sides of a respective mass car as it moves along the track, the plurality of switches being operable to control a flow of electricity to and from the electromagnetic coils while managing their activation and deactivation.

According to yet another aspect, the method further comprises dissipating heat generated by the electromagnetic coils using a cooling system. According to another aspect, the method wherein the cooling system includes a closed-loop water cooling system. According to yet another aspect, the method wherein the cooling system includes air-based cooling methods. According to another aspect, the method wherein the magnets are neodymium iron boron magnets.

According to yet another aspect, an energy storage system comprises a track extending between a lower storage yard and an upper storage yard; a first frame system extending along a first side of the track; a second frame system extending along a second side of the track; a first plurality of electromagnetic coils positioned on the first frame system and a second plurality of electromagnetic coils positioned on the second frame system, wherein the plurality of electromagnetic coils are configured to interact with permanent magnets that move along the track with a mass car.

According to another aspect, the energy storage system wherein the first frame system comprises a first plurality of switches facing the track and the second frame system comprises a second plurality of switches facing the track. The switches can be mechanical switches and/or solid state switches.

Alternative configurations for the placement of the permanent magnets within the energy storage system are provided. In some embodiments, the magnets are affixed directly to the mass cars, e.g., on their first and second sides, allowing the electromagnetic coils positioned on the frame systems to interact directly with the magnets as the mass cars move along the track. This arrangement enables the linear synchronous motor to propel the mass cars or generate electricity as they descend. In other embodiments, the magnets are instead mounted on power carts that are designed to move in tandem with the mass cars. These power carts are equipped with coupling members (e.g., arms) that project outward and engage with corresponding portions on the mass cars (e.g., arm-receiving openings), thereby coupling the power carts to the mass cars for movement along the track. The electromagnetic coils interact with the magnets on the power carts, rather than the mass cars themselves, to deliver the necessary linear force.

In some embodiments, the power carts can be disengaged from the mass cars at either end of the track and cycled back to a desired location (e.g., a point of origin) by a secondary drive system, allowing for repeated engagement and efficient operation. This modular approach provides flexibility in system design and maintenance, while ensuring optimal electromagnetic interaction for energy storage and generation.

Additional features and implementations of the disclosed energy storage solutions and methods thereof are provided herein. The foregoing and other objects, features, and advantages of the invention will become more apparent from the following detailed description, which proceeds with reference to the accompanying figures.

### BRIEF DESCRIPTION OF THE DRAWINGS

FIG. 1 shows an exemplary energy storage system with a track that extends from a lower storage yard to an upper storage yard.

FIG. 2 shows an energy storage system comprising mass cars that can be used to store and generate energy using linear synchronous motors.

FIG. 3 discloses an enlarged, partially exposed view of the structural frame, electromagnetic coils, and switches.

FIG. 4 illustrates another view of the energy storage system, showing the relative positions of the electromagnetic coils and cooling system.

FIG. 5 illustrates an arrangement of the electromagnetic coils and switches in the energy storage system.

FIG. 6 illustrates another embodiment of a system in which the mass cars engage with a power cart that extends from the motor system, with the view showing a power charging mode of operation.

FIG. 7 illustrates another embodiment of a system in which the mass cars engage with a power cart that extends from the motor system, with the view showing a power generating mode of operation.

FIG. 8 illustrates a cut-away view illustrating a motor system that utilizes power carts that engage with mass cars.

FIG. 9 illustrates an exemplary power cart with at least one projection (e.g., arm) configured to engage with a mass car.

FIG. 10 illustrates another exemplary power cart with at least one projection (e.g., arm) configured to engage with a mass car.

FIG. 11 illustrates a cutaway view of a motor system illustrating a plurality of power cars that are movably mounted to the motor system.

FIG. 12 illustrates another cutaway view of a portion of the motor system showing electromagnetic coils and a power cart movably mounted onto the motor system.

FIG. 13 illustrates a view of a system that comprises a mass car with a plurality of arm-receiving openings for engagement with one or more power carts.

### DETAILED DESCRIPTION

The detailed description herein describes various electric power energy storage systems. More particularly, this disclosure relates to a gravitational potential energy storage system that employs a plurality of linear synchronous motors that are configured to transport mass cars between a lower storage area (i.e., the discharged area) and an upper storage yard (i.e., the charged area). Potential energy is stored by employing electrical grid power to transport the masses from the lower to upper storage facility, and potential energy is recovered and dispatched to the electrical grid by generator operation of the linear synchronous motors during transport of the mass cars from the upper to lower storage yards. The energy storage systems disclosed herein advantageously allow for the full range of energy services including, for example, load shifting, peak shaving, grid inertia, and energy arbitrage, as well the full range of power services including, for example, frequency regulation, voltage regulation, load following, reactive power, contingency reserves, and black start.

The present disclosure relates to energy storage systems and methods of using the same. It should be understood that although the various embodiments described herein disclose particular methods or materials applied in specific implementations, in view of these teachings'other methods, materials, and implementations that are similar or equivalent to those described herein may be possible. As such, the following description is exemplary in nature and is not intended to limit the scope, applicability, or configuration of the disclosure in any way. Various changes to the described embodiments may be made, such as in the function and arrangement of the elements described herein, without departing from the scope of the disclosure.

As used in this application the singular forms “a,” “an,” and “the” include the plural forms unless the context clearly dictates otherwise. Additionally, the term “includes” means “comprises.” Furthermore, as used herein, the term “and/or” means any one item or combination of items in the phrase. In addition, the term “exemplary” means serving as a non-limiting example, instance, or illustration. As used herein, the terms “e.g.,” and “for example,” introduce a list of one or more non-limiting embodiments, examples, instances, and/or illustrations.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed things and methods can be used in conjunction with other things and methods. Additionally, the description sometimes uses terms like “provide,” “produce,” “determine,” and “select” to describe the disclosed methods. These terms are high-level descriptions of the actual operations that are performed. The actual operations that correspond to these terms will vary depending on the particular implementation and are readily discernible by one of ordinary skill in the art having the benefit of this disclosure.

As used herein, the terms “first”, “second”, and “third” may be used interchangeably to distinguish one component from another and are not intended to signify location or importance of the individual components.

The terms “upgrade” and “downgrade” refer to the relative direction with respect to the inclined areas and related height changes described herein. For example, an “upgrade” side of an element on an inclined area refers to a side of structure or component that is at or facing a higher elevation area as compared to a “downgrade”side which is at or facing a lower elevation area.

The terms “coupled,” “fixed,” “attached to,” and the like refer to both direct coupling, fixing, or attaching, as well as indirect coupling, fixing, or attaching through one or more intermediate components or features, unless otherwise specified herein.

As used herein, the term “electrical grid” or “power grid” refers to an interconnected network for delivering electricity from producers to consumers. Among other things, the electrical grid can include generating stations that produce power, electrical substations for stepping electrical voltage up for transmission, or down for distribution, and transmission and distribution lines that carry power and/or connect consumers to the electrical substations.

As used herein, the term “mass car” refers to any moveable mass structure on wheels (or other rolling elements) or otherwise transportable from one location to another location having a different potential energy.

As used herein, the term “track” refers to any defined travel pathway for a mass car. A track can, for example, be comprised of one or more rails, or in some embodiments two or more rails, that extend along a ground surface to restrict movement of one or more mass cars away from, or out of, the defined travel pathway. The rails can be formed from any firm surface that is capable of supporting the mass cars, such as iron, and can be of any suitable shape, such as flat, raised, or recessed.

As noted above, the systems and methods described herein, and individual components thereof, should not be construed as being limited to the particular uses or systems described herein in any way. Instead, this disclosure is directed toward all novel and non-obvious features and aspects of the various disclosed embodiments, alone and in various combinations and sub combinations with one another. For example, any features or aspects of the disclosed embodiments can be used in various combinations and subcombinations with one another, as will be recognized by an ordinarily skilled artisan in the relevant field(s) in view of the information disclosed herein. In addition, the disclosed systems, methods, and components thereof are not limited to any specific aspect or feature or combinations thereof, nor do the disclosed things and methods require that any one or more specific advantages be present or problems be solved.

The energy storage system described herein utilizes linear synchronous motor(s) to move mass cars along an inclined plane between a lower storage yard and an upper storage yard. Linear synchronous motors operate on the principle of synchronous motion, where the speed of the motor is synchronized with the frequency of the supply current. In this system, the linear synchronous motor(s) are strategically positioned along the track to provide the necessary propulsion for the mass cars. The motors comprise electromagnetic coils that interact with permanent magnets (e.g., neodymium iron boron magnets) mounted on the mass cars. When an alternating current is supplied to the electromagnetic coils, a traveling magnetic field is generated, which interacts with the magnets on the mass cars to produce a linear force that moves the cars along the track.

During the charging mode, the linear synchronous motor(s) acts as a motor, drawing electrical energy from the grid to move the mass cars from the lower storage yard to the upper storage yard. The synchronization with the grid ensures that the motors operate at a constant speed, corresponding to the grid frequency. This eliminates the need for complex control mechanisms and variable frequency drives, simplifying the system's operation and reducing potential points of failure.

During the generating mode, the linear synchronous motor(s) acts as a generator. As the mass cars descend from the upper storage yard to the lower storage yard, the motion of the cars induces a current in the electromagnetic coils. The generated current is synchronized with the grid frequency, allowing the electrical energy to be seamlessly fed back into the grid. This process converts the potential energy of the descending mass cars into electrical energy, providing a renewable energy source that is in phase with the grid.

The use of linear synchronous motor(s) in this energy storage system offers several advantages. First, the synchronization with the electrical grid eliminates the need for complex control mechanisms and variable frequency drives, simplifying the system's operation. Second, the high efficiency of linear synchronous motors ensures minimal energy loss during the conversion processes, maximizing the overall efficiency of the energy storage system. Third, the precise control over the movement of the mass cars provided by the linear synchronous motors allows for smooth and reliable operation, enhancing the system's performance and longevity. Fourth, the generated electrical energy is in phase with the grid frequency, allowing for seamless integration and dispatch of energy back into the grid. Overall, the grid synchronization of linear synchronous motors in this energy storage system ensures efficient, reliable, and simplified operation, making it an effective solution for grid-scale energy storage and renewable energy generation.

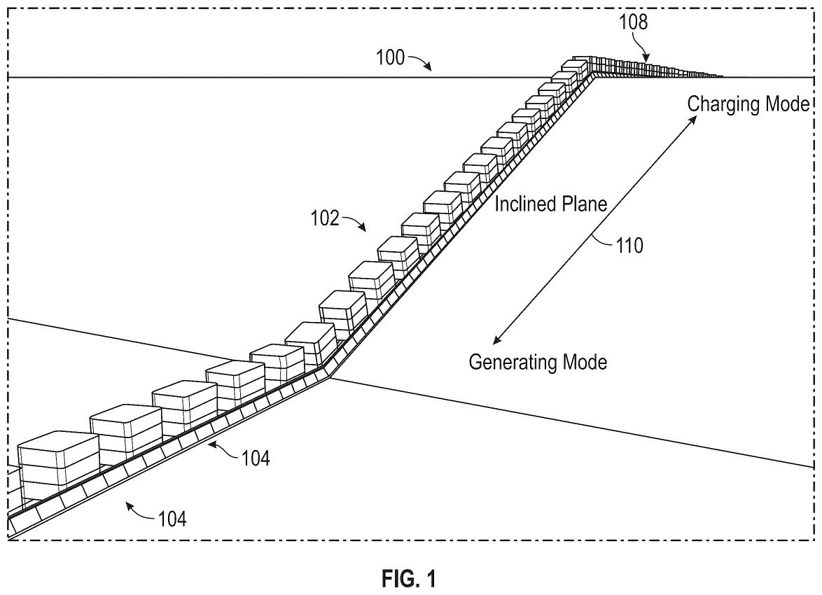

FIG. 1 illustrates an exemplary energy storage system 100 comprising a plurality of mass cars 102 that are configured to move along at least one track 104 to and from a lower storage yard 106 (e.g., a discharged area) and an upper storage yard 108 (e.g., a charged area).

The lower storage yard 106 and upper storage yard 108 are separated by an inclined area 110 (e.g., a slope).

The inclined plane 105 has a slope length l, a run d, a height h, and an angle of inclination α. A wide range of energy storage needs can be met by scaling the energy storage system and adjusting, for example, the number of tracks, the number and size of mass cars, and/or the change in height between the lower storage yard and the upper storage yard. In some embodiments, for example, the inclined area can have a grade (h/d*100) that ranges from 35% to 215%, 1% to 34%, or in other embodiments from 216% to 200,000%. The change in height between the lower storage yard and the upper storage yard can be in some embodiments, between 200 and 1,000 feet, or in others less than 200 feet or more than 1,000 feet.

FIG. 1 illustrates a system that has a single track 104 for convenience. However, the number of tracks 104 can vary and in many cases more than one track is desirable. Thus, the energy storage system 100 is readily scalable, depending on the site size. The number of tracks 104 provided can be selected based on a desired maximum power demand that the energy storage system is designed to meet. In some embodiments, the number of tracks can be greater than 1, greater than 5, or greater than 7. Although there is no technical maximum limitation for the number of tracks, in some embodiments, the number of tracks can be less than 10 or less than 20, such as 1-20, 5-20, or 5-10 tracks.

The energy storage system 100 utilizes the movement of mass cars 102 to store and generate energy. The mass cars 102 are designed to move along the track 104, which extends from the lower storage yard 106 to the upper storage yard 108. The track 104 can be configured, in some embodiments, to guide the movement of the mass cars 102, ensuring they follow a defined path between the storage yards. Alternatively, or in addition, other structures such as a frame on one or both sides of the track can operate to guide the mass car movement.

The lower storage yard 106 serves as the starting point for the mass cars 102 during the charging mode. In this mode, the mass cars 102 are moved from the lower storage yard 106 to the upper storage yard 108, storing potential energy. The upper storage yard 108 is the endpoint for the mass cars 102 during the charging mode and the starting point during the generating mode. In the generating mode, the mass cars 102 descend from the upper storage yard 108 to the lower storage yard 106, converting potential energy into electrical energy.

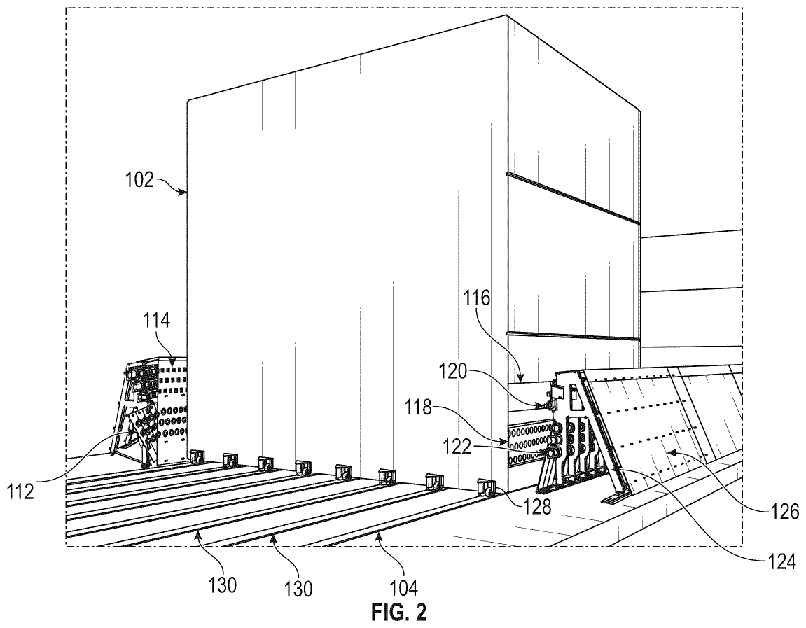

FIG. 2 illustrates an energy storage system comprising a mass car 102, electromagnetic coils 112, switches 114, a switch contact plate 116, permanent magnets 118, an electrical busbar 120, a cooling system 122, a track 104, a frame system 124, and an enclosure shroud 126.

The mass car 102 is configured to move along the track 104, which, in the exemplary embodiment, is comprised of multiple rail segments 130. The mass car 102 can include a plurality of wheel assemblies 128 that permit it to move smoothly along the track 104. The number of wheel assemblies 128 can vary depending on the track surface. For example, in the exemplary embodiment shown in FIG. 2, each track 104 comprises a plurality of rail segments 130 (eight) onto which the wheel assemblies 128 are aligned.

The electromagnetic coils 112 are positioned along the track 104 and interact with the neodymium iron boron magnets 118 mounted on the mass car 102 as the mass car moves along the track 104. This interaction creates a magnetic field that drives the mass car 102 along the track 104. The electromagnetic coils 112 are responsible for generating the electromagnetic force required for the movement of the mass car 102.

The switches 114 control the flow of electricity to the electromagnetic coils 112. The switches 114 are strategically placed to manage the activation and deactivation of the electromagnetic coils 112, ensuring precise control over the movement of the mass car 102. The switch contact plate 116 is part of the switching mechanism that ensures proper electrical contact between the switches 114 and the electromagnetic coils 112, maintaining the efficiency and reliability of the energy storage system.

The electrical busbar 120 distributes electrical power to the various components of the energy storage system. The busbar 120 ensures that the electromagnetic coils 112 and other electrical components receive the necessary power for operation.

The cooling system 122 is integrated into the energy storage system to manage the heat generated by the electromagnetic coils 112 and other electrical components. The cooling system 122 ensures that the components operate within safe temperature ranges, preventing overheating and maintaining system efficiency. By effectively dissipating heat, the cooling system 122 enhances the reliability and longevity of the linear synchronous motor(s) and associated components.

The cooling system 122 can include various cooling technologies, such as liquid cooling, to effectively dissipate heat. In a liquid cooling setup, a closed-loop system circulates a coolant (e.g., water or a specialized cooling fluid) through the electromagnetic coils 112 and other heat-generating components. The coolant absorbs heat from these components and transfers it to a heat exchanger, where the heat is dissipated into the surrounding environment. This process ensures that the components remain at optimal operating temperatures.

In some embodiments, the system may also incorporate air-based cooling methods. For example, fans or blowers can be used to direct airflow over the electromagnetic coils 112 and other components, enhancing heat dissipation. Additionally, heat sinks or thermal pads may be employed to increase the surface area for heat transfer, further improving the cooling efficiency.

The cooling system 122 is designed to be robust and reliable, ensuring continuous operation of the energy storage system under various environmental conditions. By effectively managing the thermal load, the cooling system 122 helps maintain the performance and efficiency of the linear synchronous motor(s) and other electrical components, thereby enhancing the overall reliability and longevity of the energy storage system.

The frame system 124 supports the various components of the energy storage system, including the electromagnetic coils 112 and switches 114. The frame system 124 ensures the stability and integrity of the system, allowing it to withstand the forces generated during operation. In some embodiments, the frame system 124 can help guide and/or maintain the movement of the mass cars along the track 104. For example, in some systems, the frame system 124 can include guide rails or other alignment mechanisms that ensure the mass cars 102 follow a precise path along the track 104. These alignment features help maintain the correct orientation and direction of the mass cars, preventing lateral or vertical deviations that could affect their movement. For example, in the exemplary figures the position of the frame systems would also serve to prevent the mass cars from leaving the track surface or otherwise being misaligned.

The enclosure shroud 126 protects the components of the energy storage system from external elements. The enclosure shroud 126 ensures that the system operates in a controlled environment, reducing the risk of damage and maintaining the efficiency of the system.

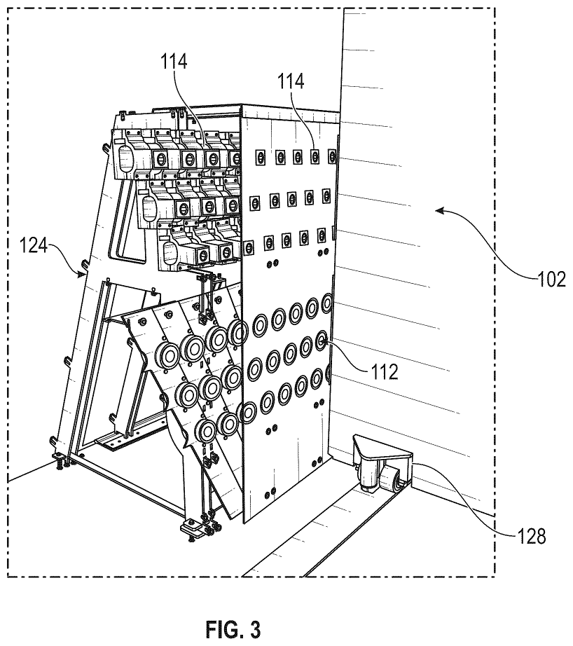

FIG. 3 discloses an enlarged, partially exposed view of the structural frame 124, electromagnetic coils 112, and switches 114.

The interaction between the electromagnetic coils 112 and the permanent magnets (e.g., neodymium iron boron magnets) 118 mounted on the mass car 102 is fundamental to the operation of the energy storage system. This interaction generates the necessary forces to move the mass car 102 along the track 104, enabling both the storage and generation of energy.

Neodymium iron boron magnets can be particularly effective for use with the energy storage system described herein; however, other types of permanent magnets can be used, so long as they are capable of supporting the linear synchronous motor-based systems described herein.

The electromagnetic coils 112 are strategically positioned along the frame system 124 that extends along track 104 and the magnets 118 are arranged on the mass cars 102 to interact with the magnetic fields generated by the electromagnetic coils 112 as each mass car 102 moves along the track 104.

During the charging mode, the electromagnetic coils 112 act as motors. The AC power from the electrical grid energizes the coils, creating a traveling magnetic field that interacts with the magnets on the mass car 102. This interaction generates a propelling force that moves the mass car 102 from the lower storage yard 106 to the upper storage yard 108, storing potential energy in the process.

During the generating mode, the mass car 102 descends from the upper storage yard 108 to the lower storage yard 106. As the mass car 102 moves, the magnets 118 induce a current in the electromagnetic coils 112. This induced current is synchronized with the grid frequency, allowing the generated electrical energy to be fed back into the electrical grid. The interaction between the descending mass car 102 and the coils 112 converts the potential energy of the mass car 102 into electrical energy.

A synchronization mechanism of the control system for the energy storage system ensures that the traveling magnetic field generated by the electromagnetic coils 112 is in phase with the frequency of the electrical grid. This synchronization eliminates the need for complex control mechanisms and variable frequency drives, simplifying the system's operation and enhancing its reliability.

The switches 114 control the flow of electricity to the electromagnetic coils. The switches are strategically placed to manage the activation and deactivation of the coils, ensuring precise control over the movement of the mass car.

The switches 114 are positioned on the frame systems 124 to manage the activation and deactivation of the electromagnetic coils 112 as the mass cars 102 move along the track 104. Any suitable switching device that can identify the position of the mass can be used. The switches 114 can be, for example, mechanical switches that engage with the switch contact plate 116 as the mass car moves along the track 104. When the switch is closed (i.e., in contact with the switch contact plate 116 of mass car 102), electricity can flow through to the electromagnetic coils. When the switch is open, the contacts are separated from the switch contact plate 116, interrupting the flow of electricity.

The engagement of the switches 114 with the switch contact plate 116 is precisely controlled to ensure the correct timing and sequence of coil activation. This control is managed by the control system, which can also monitor the position and speed of the mass cars 102. The control system sends signals to the electromagnetic coils 112 to cause them to activate and deactivate in the correct sequence, providing smooth and efficient movement of the mass cars 102.

Alternatively, or in addition, to mechanical switches, the energy storage system can use solid-state switches. Solid-state switches can be easily integrated with the control system of the energy storage system, which can send and receive electronic signals from the solid-state switches to determine when to activate and deactivate the electromagnetic coils.

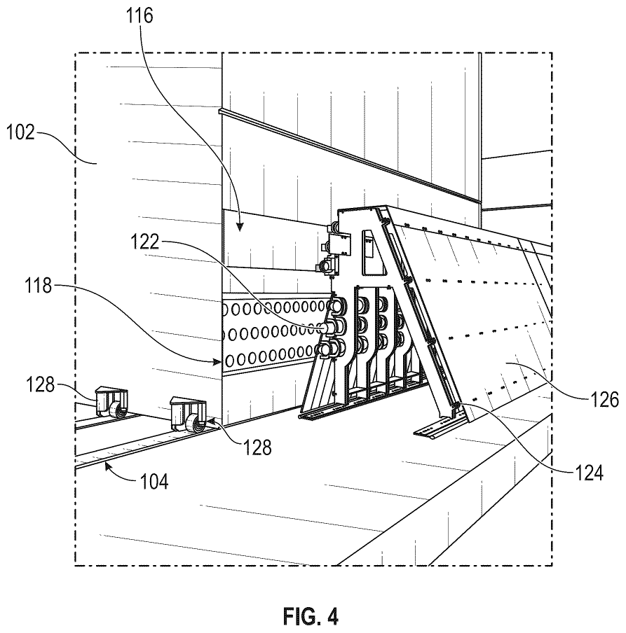

FIG. 4 illustrates another view of the energy storage system, illustrating the positions of the cooling system 122 relative to magnets 118 and their respective coils. The coils generate significant heat during operation, and the cooling system 122 is responsible for dissipating this heat to maintain optimal operating temperatures as described above.

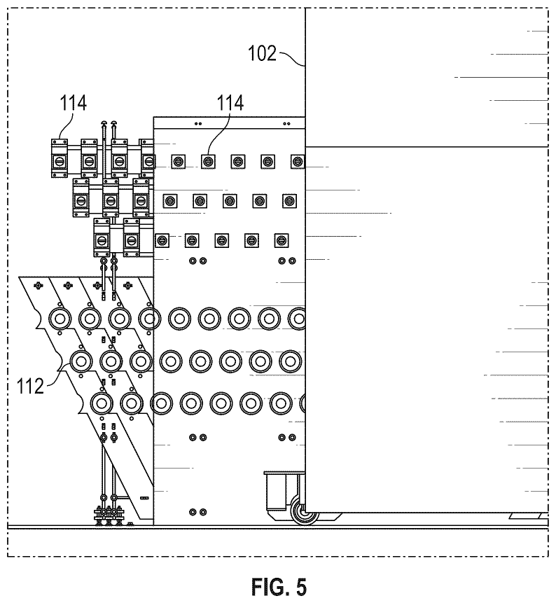

FIG. 5 illustrates another view of the energy storage system, illustrating an exemplary arrangement of the electromagnetic coils 112 and switches 114. As shown in FIG. 5, the electromagnetic coils 112 are positioned along the frame system 124 in a staggered arrangement. This means that the coils are not aligned in a single column but are instead vertically offset from one another. This staggered configuration allows for a more even distribution of the magnetic field along the track, ensuring that the mass car 102 experiences a consistent propelling force as it moves.

The switches 114 are also arranged in a similar staggered pattern. These switches control the flow of electricity to the electromagnetic coils 112, managing their activation and deactivation. The staggered arrangement of the switches ensures that the coils are energized in a precise sequence, providing smooth and efficient movement of the mass car 102.

The staggered arrangement of the electromagnetic coils 112 also enhances the distribution of the magnetic field along the track. By offsetting the coils, the system can create overlapping magnetic fields that provide a more uniform force on the mass car 102. The staggered arrangement allows for precise control and timing of the activation and deactivation of the coils and switches. The central control system can manage the sequence of coil activation more effectively, ensuring that the mass car 102 moves smoothly and efficiently along the track.

The linear synchronous motor-based systems described herein are preferably configured to operate at a speed that is synchronized with the frequency of the electrical grid. This means that the speed of the linear motors is directly proportional to the grid frequency, ensuring that the motors move the mass cars at a constant and predictable rate.

As discussed above, the control system for the energy storage system includes a synchronization mechanism. The synchronization mechanisms helps ensures that the operation of the linear synchronous motor-based systems is aligned with the grid frequency. This control system monitors the frequency of the electrical grid and adjusts the timing of the current supplied to the electromagnetic coils accordingly. By doing so, it ensures that the traveling magnetic field generated by the coils is in phase with the grid frequency. In addition, the control system can ensure that the energy drawn from the grid during the charging mode is in phase with the grid's AC frequency. This seamless integration allows the system to efficiently draw electrical energy from the grid to move the mass cars from the lower storage yard to the upper storage yard, storing potential energy in the process.

Although described above with respect to a three-phase AC grid system, the energy storage system described herein can be designed to operate with any type of electrical system, including a three-phase alternating current (AC) system or a direct current (DC), depending on the specific requirements and design considerations. Three-phase AC is commonly used in industrial and large-scale energy systems due to its efficiency and ability to deliver consistent power, and the linear synchronous motor-based systems described herein are very effective for receiving and delivering electrical power to and from a three-phase AC system. However, in some applications, the energy storage systems described herein may be used with a direct current (DC) system, which may be desired for its simplicity and the ability to integrate easily with certain renewable energy sources such as solar panels or batteries.

In some cases, the energy storage system may be designed as a hybrid system that can operate with both three-phase AC and DC power. This flexibility allows the system to integrate with a wide range of power sources and adapt to different operational requirements.

In addition, because the linear synchronous motor(s) can be synchronized with the grid frequency, there is no need for variable frequency drives (VFDs) to control the speed of the motors. This simplifies the system's operation and reduces potential points of failure, as the motors naturally operate at a speed that matches the grid frequency.

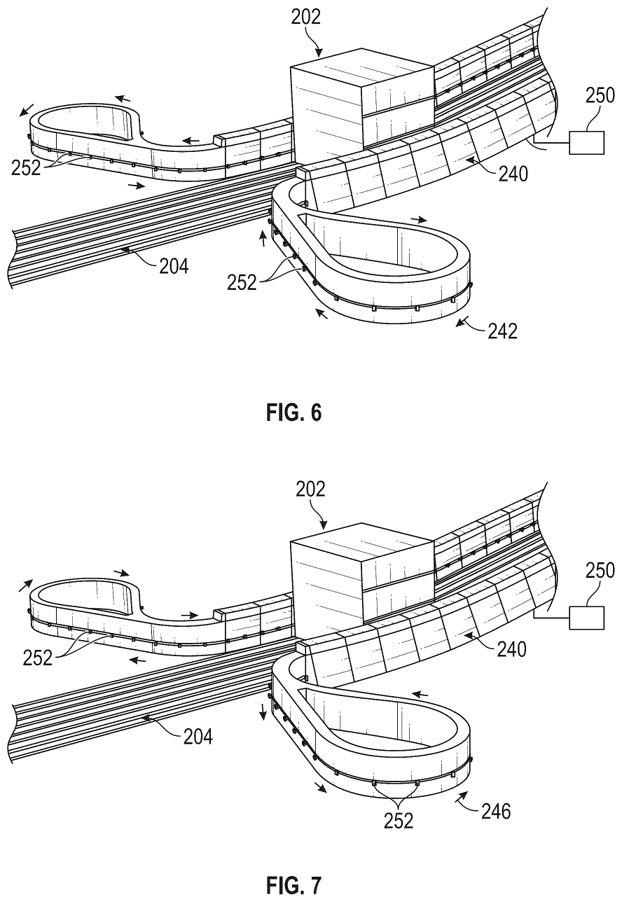

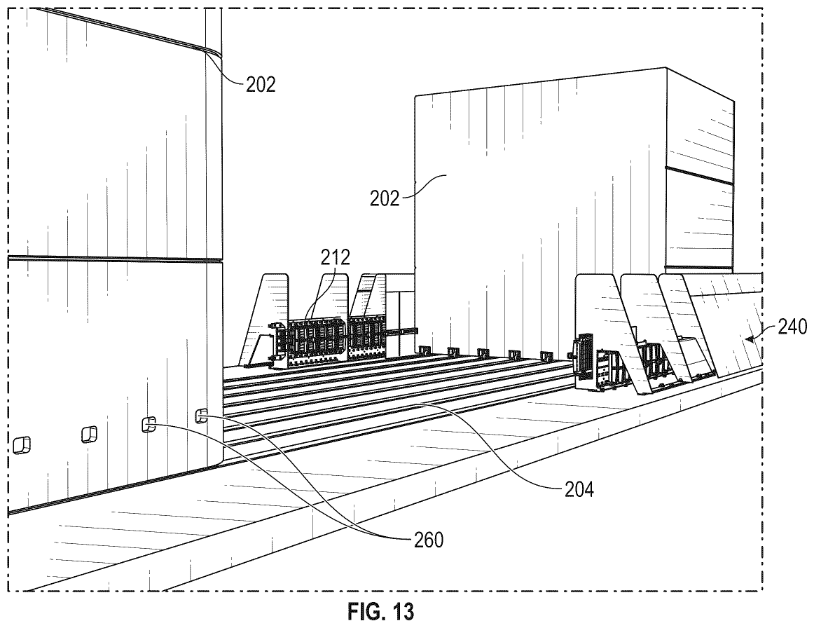

In the embodiments illustrated in FIGS. 6-13, the energy storage system utilizes power carts 248 (also referred to as sleds) that serve as intermediary components between the motor system 240 and the mass cars 202. The power carts 248 are equipped with arms 252 (e.g., projecting members) that project outward through the motor system 240 and engage with arm-receiving openings 260 (e.g., pockets as shown in FIG. 13) on the mass cars 202, allowing for a detachable and reusable coupling mechanism. The power carts 248 themselves interact with the electromagnetic coils 212 of the motor system 240, and can be cycled between the top and bottom of the inclined plane by a secondary drive system 250 as shown in FIGS. 6 and 7. The secondary drive system 250 can be a secondary motor system that drives a belt or wheel assembly to move the individual power carts 248, individually or collectively, from one position along the inclined plane (e.g., the bottom) to another position along the inclined plane (e.g., the top).

This approach is distinct from the embodiments shown in FIGS. 1-5, where the permanent magnets are affixed directly to the mass cars and the electromagnetic coils act directly upon these magnets to propel or generate energy as the mass cars move along the track. In other words, in the FIGS. 1-5 embodiments there is no intermediary power cart and the mass cars carry the magnets that interact with the motor system.

The use of power carts in FIGS. 6-13 provides operational flexibility, as the carts can be quickly engaged or disengaged from mass cars and recirculated for reuse, potentially improving system efficiency, maintenance, and scalability. In contrast, the direct coupling of magnets to mass cars in FIGS. 1-5 results in a simpler, more integrated design but may limit the ability to rapidly cycle or reuse the propulsion interface.

Utilizing power carts to carry the magnets, rather than affixing the magnets directly to the mass cars, can provide significant advantages in terms of power delivery and system performance. By mounting the magnets on dedicated power carts, the system can achieve much tighter mechanical and electromagnetic tolerances between the movable magnets and the stationary coils of the motor system. This precision is more difficult to achieve when the magnets are mounted directly on the mass cars, which may vary in size, weight, or structural configuration, and may be subject to greater mechanical flex or misalignment during operation. The dedicated design of the power carts ensures that the magnets remain at a more consistent distance from the coils, maximizing the strength and uniformity of the electromagnetic interaction.

Better tolerances between the magnets and coils result in more efficient transfer of electromagnetic force, leading to improved acceleration, deceleration, and overall energy conversion efficiency. The reduced air gap and consistent alignment minimize losses due to stray fields or uneven force application, allowing the motor system to deliver power more effectively and predictably. In addition, if a power cart fails it can be more easily replaced since the power carts are separately formed and constructed from the mass cars.

FIGS. 6 and 7 illustrates a system in which power carts are positioned within the motor system 240 adjacent to the track. Each power cart is equipped with outwardly projecting arms 252 that extend through the motor system 240 structure. Electromagnetic coils are arranged along the motor system 240, and the power carts are positioned to engage with the mass cars 202 and interact with these coils (as discussed in more detail below), enabling the transfer of electromagnetic force for propulsion or generation. FIG. 6 illustrates the system in a charging configuration, in which mass cars 202 are moved along the track 204 up the incline and FIG. 7 illustrates the system in a generating configuration, in which mass cars 202 are moved along the track 204 down the incline.

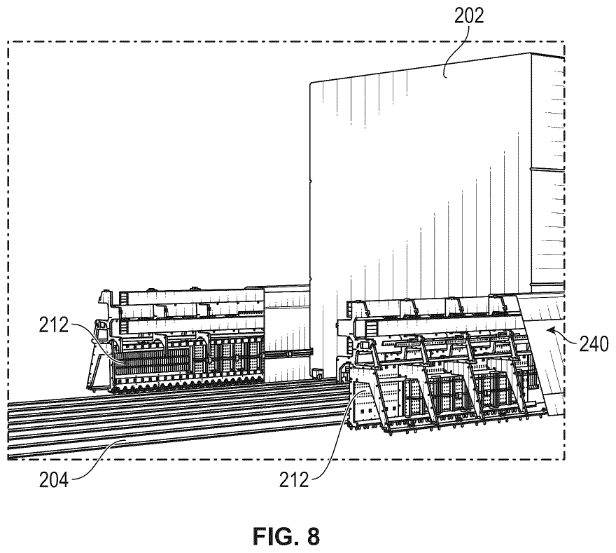

A secondary drive system 250 is illustrated as being operable to cycle the power carts from the bottom to the top of the inclined plane, or vice versa, allowing for repeated use and efficient system operation. The secondary drive system 250 can utilize a pulley or wheel system that uses a secondary motor to move the power carts from one location to another. As shown in FIGS. 6 and 7, the power carts can be driven in a loop such that when they reach the bottom, they can be returned to the top by the secondary drive system 250. FIG. 8 presents a detailed view of the motor system 240, showing the coils 212 and power carts of the motor system 240 and their location proximate the mass car 202.

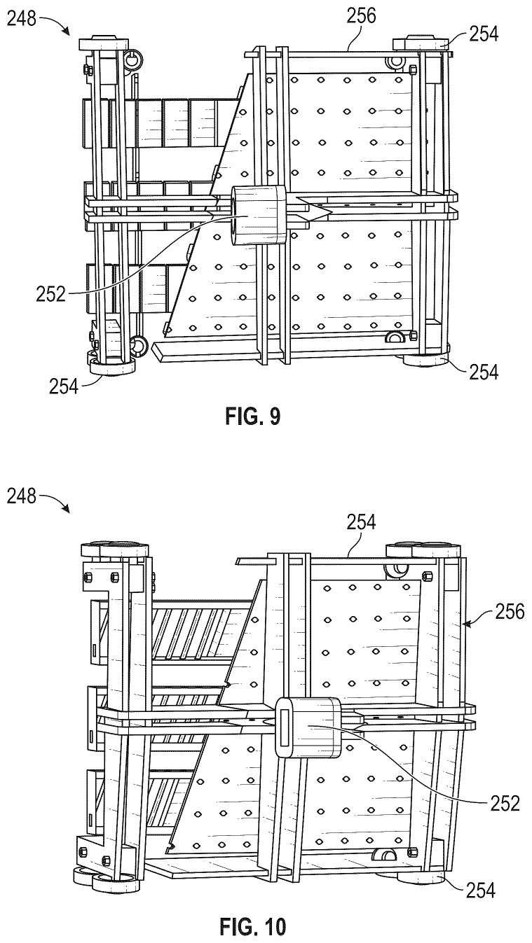

The power carts in the energy storage system can be configured in different forms to optimize their interaction with the motor system and the mass cars, as illustrated in FIG. 9 and FIG. 10. In the embodiment shown in FIG. 9, the power cart 248 is a permanent magnet motor sled. In this configuration, the sled incorporates a series of permanent magnets arranged along its body in a manner that is interacts with the stationary electromagnetic coils of the motor system. As the coils are energized, the traveling magnetic field interacts directly with the permanent magnets on the sled, generating a linear force that propels the sled—and any engaged mass car—along the track. This arrangement allows for high efficiency and strong, consistent force delivery, as the permanent magnets provide a stable and predictable magnetic field for the motor system to act upon.

In another example, FIG. 10 illustrates a power cart formed as a squirrel cage reduction motor system. In this embodiment, the sled is equipped with a squirrel cage rotor. When alternating current is supplied to the stationary coils, a rotating magnetic field is produced, which induces currents in the squirrel cage rotor of the sled. These induced currents generate their own magnetic field, resulting in a force that moves the sled along the track.

Both embodiments allow the power carts to serve as the primary interface between the motor system and the mass cars. The choice between these configurations (or other similar configurations) can be made based on the specific requirements of the energy storage system, such as desired efficiency, maintenance considerations, and operational environment.

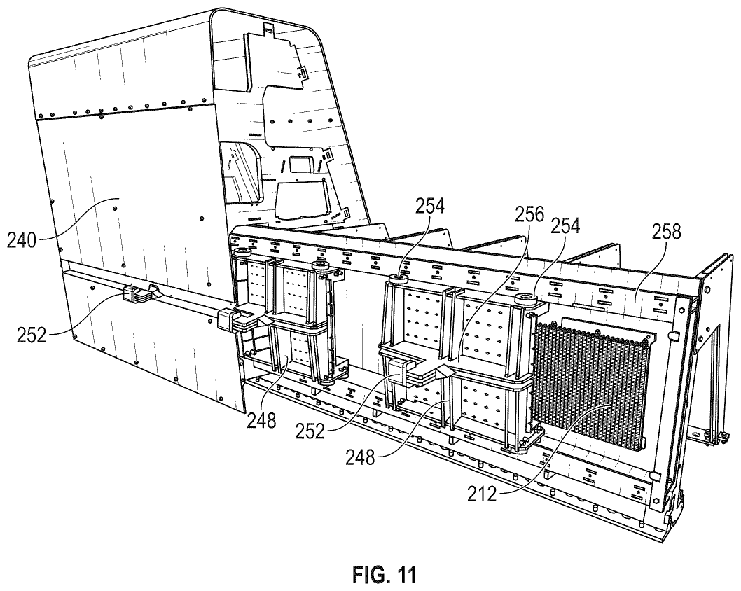

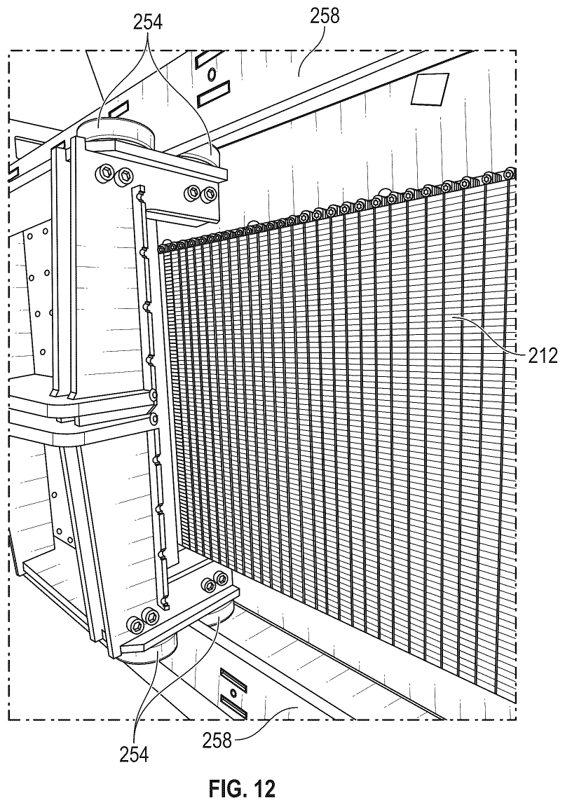

As shown in both FIGS. 9 and 10, the power carts 248 can be equipped with sets of wheels positioned to roll along defined surfaces or rails that are part of the structural frame 258 of the motor system 240 (FIGS. 11 and 12). As the power cart moves, the wheels engage with these surfaces or rails, ensuring that the cart remains properly aligned and positioned relative to the stationary electromagnetic coils. The wheels can also reduce lateral or vertical deviation, keeping the power cart stable and centered as it travels along the track. Additionally, the wheel and rail system allows the power cart to be easily cycled by the secondary drive system, such as a pulley belt or wheel assembly, without risk of misalignment or derailment.

FIGS. 11 and 12 provide a cross-sectional views of the motor system 240, highlighting the interaction between the power carts 248, electromagnetic coils 212, and mass cars 202. The figure shows the arms 252 of the power carts projecting through the motor system 240 structure, which allows them to engage with pockets (FIG. 13) on the mass cars 202. As shown in FIG. 12, a plurality of pairs of wheels 254 can be provided to securely guide the power carts 248 along the length of the motor system 240.

FIG. 13 illustrates how the arms 252 of the power carts 248 can engage with the mass cars 202. Specifically, the mass cars have a plurality of arm-receiving openings 260 (e.g., pockets) that allow for the arms to be received therein to couple the mass cars with one or more power carts.

The number and size of the power carts can vary. For example, in some embodiments a mass car can engage with a single power cart or with a larger number of power carts (e.g., 6, 10, 20). In one embodiment, each mass car can engage with 3, 6, 9, or 12 power carts on each size for a total of, respectively, 6, 12, 18, or 24 power carts per mass car. In addition, although the sleds illustrated in FIGS. 9 and 10 illustrate a single arm for each power cart, it should be understood that any suitable numbers of arms (or other engagement mechanisms) are possible, such as 2, 4, or 8 arms per power cart.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims.

1. An energy storage system comprising:
a track extending between a lower storage yard and an upper storage yard;
a first frame system extending along a first side of the track;
a second frame system extending along a second side of the track;
a plurality of mass cars configured to move along the track between the first frame system and the second frame system, each mass car of the plurality of mass cars having a first side, a second side;
a plurality of permanent magnets configured to move along the track with the plurality of mass cars;
wherein the first frame system and the second frame system each comprises:
a plurality of fixed electromagnetic coils; and
a plurality of switches positioned on the frame to engage with a respective mass car as it moves along the track, the plurality of switches being operable to control a flow of electricity to the electromagnetic coils to manage their activation and deactivation,
wherein the plurality of permanent magnets are positioned to electromagnetically engage with at least some of the plurality of fixed electromagnetic coils as a respective mass car moves along the track.

2. The energy storage system of claim 1, further comprising:
an electrical busbar configured to distribute electrical power to the electromagnetic coils; and
a cooling system configured to dissipate heat generated by the electromagnetic coils.

3. The energy storage system of claim 1, wherein the energy storage system has a charging mode and a generator mode, and wherein the energy storage system is configured to:
draw electrical energy from the electrical grid to move the mass cars from the lower storage yard to the upper storage yard, storing potential energy in the mass cars during the charging mode; and
convert the potential energy of the mass cars into electrical energy as the mass cars descend from the upper storage yard to the lower storage yard, feeding the generated electrical energy back into the electrical grid during the generator mode.

4. The energy storage system of claim 1, further comprising a control system configured to align the operation of the energy storage system with the alternating current of an electrical grid for synchronized operation of the energy storage system.

5. The energy storage system of claim 1, wherein the magnets are neodymium iron boron magnets.

6. The energy storage system of claim 1, wherein the switches are mechanical switches that are configured to physically contact the first side or second side of the respective mass car.

7. The energy storage system of claim 1, wherein the plurality of permanent magnets are affixed to the first side and the second side of each mass car.

8. The energy storage system of claim 1, wherein the plurality of permanent magnets are affixed to power carts configured to engage with the mass cars, such that the permanent magnets move along the track with the power carts when the power carts are engaged with the mass cars.

9. The energy storage system of claim 8, wherein the power carts are configured to selectively engage and disengage with the mass cars at predetermined locations along the track.

10. The energy storage system of claim 9, wherein each power cart comprises at least one arm configured to project outward and engage with a corresponding arm-receiving opening on a mass car, thereby coupling the power cart to the mass car for movement along the track.

11. A method for storing and generating energy using one or more linear synchronous motor, the method comprising:
providing a track extending between a lower storage yard and an upper storage yard;
positioning a plurality of mass cars configured to move along the track;
positioning the one or more linear synchronous motor along the track, each linear synchronous motor comprising electromagnetic coils configured to interact with permanent magnets configured to move with the mass cars to generate a linear force for moving the mass cars along the track;
synchronizing the operation of the one or more linear synchronous motor with the alternating current of an electrical grid; and
during a charging mode:
drawing electrical energy from the electrical grid to energize the electromagnetic coils;
moving the mass cars from the lower storage yard to the upper storage yard, thereby storing potential energy in the mass cars; and
during a generating mode:
allowing the mass cars to descend from the upper storage yard to the lower storage yard;
converting the potential energy of the descending mass cars into electrical energy by inducing a current in the electromagnetic coils; and
feeding the generated electrical energy back into the electrical grid.

12. The method of claim 11, further comprising positioning a first frame system extending along a first side of the track and a second frame system extending along a second side of the track, wherein the electromagnetic coils are positioned on the first frame system and on the second frame system.

13. The method of claim 11, further comprising positioning a plurality of switches on the first frame system and the second frame system to engage with both sides of a respective mass car as it moves along the track, the plurality of switches being operable to control a flow of electricity to the electromagnetic coils to manage their activation and deactivation.

14. The method of claim 11, further comprising dissipating heat generated by the electromagnetic coils using a cooling system.

15. The method of claim 14, wherein the cooling system includes a closed-loop water cooling system.

16. The method of claim 14, wherein the cooling system includes air-based cooling methods.

17. The method of claim 11, wherein the permanent magnets are affixed directly to the mass cars such that the electromagnetic coils interact with the magnets on the mass cars to generate a linear force for moving the mass cars along the track.

18. The method of claim 11, wherein the permanent magnets are affixed to power carts, and the power carts are configured to engage with the mass cars so that the electromagnetic coils interact with the magnets on the power carts to generate a linear force for moving the mass cars along the track.

19. The method of claim 18, wherein each power cart comprises at least one arm configured to project outward and engage with a corresponding arm-receiving opening on a mass car, thereby coupling the power cart to the mass car for movement along the track.

20. The method of claim 18, further comprising cycling the power carts between the lower storage yard and the upper storage yard by a secondary drive system for repeated engagement with mass cars.
